(19) United States
(12) Patent Application Publication
(10) Pub. No.: US 2015/0358764 A1
(43) Pub. Date: Dec. 10, 2015

(54) SYSTEMS AND METHODS FOR INTEREST- AND LOCATION-BASED CONVERSATION MATCHING

(71) Applicant: Patrick S. Piemonte, San Francisco, CA (US)

(72) Inventor: Patrick S. Piemonte, San Francisco, CA (US)

(21) Appl. No.: 14/300,405

(22) Filed: Jun. 10, 2014

(51) Int. Cl. H04W 4/02; H04W 4/24; G06F 17/30

(52) U.S. Cl. CPC H04W 4/02; G06F 17/30241; G06F 17/30991; H04W 4/24

(57) ABSTRACT

Methods, hardware, and software connect users for conversation purposes based on an inquiry matched against a location or description from potential conversation members. Users are matched or sorted and then provided in response to the inquiry. Users can interact with these results and information therein to select a particular conversation partner. When selected, the users are placed into a conversation. The conversation may be paid for beforehand or through metering, and a portion of payment may be provided to the non-paying conversation partner to reward availability and usefulness in the conversation. Users can move between conversation partners and reformat matching results. The functionality can be executed on a mobile computing device or any other networked computer. Conversations and all other provided information can be kept anonymous, and quality of conversation partners may be maintained by ratings and feedback.

### BACKGROUND

Communications devices are conventionally capable of communicating verbal information through several different protocols, including transmission of spoken words or digitized audible data over analog lines, cellular wireless networks, digital networks using VoIP, etc. In order to find a conversation partner, users of communications devices may consult a directory of personal contacts or professional advertisements, for example, stored on the device or in an external directory like a phonebook or online listing. On mobile communications devices, native programming or applications may permit searching and selection of a conversation partner through such a locally stored or remotely retrieved database, with users typically selecting conversation partner by name or phone number

Location services on communications devices permit users to locate and potentially identify nearby individuals. Such location services may operate via GPS, local network identification, cellular triangulation, user input location, etc. Through location-determining services, users may also determine if potential communications partners are nearby in selecting the same. Through proper matching of available location information, identify, and/or contact information stored on a communications device or available through a network, users may contact, or attempt to contact, conversation partners in desired locations to converse through their communications devices.

### SUMMARY

Example embodiments and methods include actions, hardware, and software for connecting users for conversation purposes through an application. Example methods use a search term from one user input in the application to find a second user for the first user to talk to, potentially also through the application. The search can include a number of matching and sorting actions based on several different pieces of available data, including a simple comparison of the entered search term with a descriptive blurb provided by one or more other users and/or a subtraction between user locations to rank potential matches by distance. The application then shows the results to the user, which may be ranked by goodness of fit based on the matching. The user can browse or reorder the results or change the search terms, as well as consider any blurbs or other information about the users provided in the results, which may nonetheless be anonymous. Once the user is satisfied with a particular match result, the user can select that result and be placed on a call with the matching other user. The searching user may pay for the matching and call based on any number of criteria like call length, user quality, search term, payment method, etc. This may be done for several different users across several different potential matches. The application may be run on any computerized device, and all searching, results, payment, conversation, etc. can also occur through the application or through mediation of a central server. A portion of payment may be provided to the conversation partner in order to encourage users to make themselves available and useful through conversation on the application. All conversations can be kept anonymous and screened for unwanted activity, and users can provide ratings and commentary on their experience, to ensure that the conversations are useful and highest quality.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment conversation-matching network.

FIG. 2 is a flow chart showing an example method of connecting conversation partners.

FIG. 3 is an example graphical user interface useable in example methods.

FIG. 4 is an example graphical user interface useable in example methods.

FIG. 5 is an example graphical user interface useable in example methods.

FIG. 6 is an example graphical user interface useable in example methods.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange routes between two devices, including intermediary devices, networks, etc., connected wirelessly or not.

As used herein, the singular forms “a”,“an” and “the” and the plural form “indicia” are intended to include both the singular and plural forms, unless the language explicitly indicates otherwise. It will be further understood that the terms “comprises,” “comprising,” “includes,” and/or “including,” when used herein, specify the presence of stated features, integers, steps, operations, elements, and/or components, but do not themselves preclude the presence or addition of one or more other features, integers, steps, operations, elements, components, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

The inventor has recognized that human interaction is often desired to resolve problems or confusion, as well as to learn communications skills and receive nuanced opinion. While people are often able to connect with existing contacts or reference directories of professional services to address these needs, there is no guarantee of availability or ability from such persons to address a very specific problem or question or provide opinion-through-experience with a unique situation or location. Further, while people may be able to search the Internet or other reference materials to address these needs, these sources may be outdated or lack human contextual opinion on a subject from first-hand experience. To overcome these newly-recognized problems as well as others, the inventor has developed systems that both incentivize people to offer high-quality, real-time, personal help and/or opinion through conversation through payment and/or feedback, while matching persons in need of such help and opinion with suited conversation partners based on an easily-performed search and/or review of the potential partners through nearly ubiquitous communications devices.

The present invention is devices, storage-bound software, and methods for connecting conversation partners based on submitted conversation interests and abilities. In contrast to the present invention, the few example embodiments and example methods discussed below illustrate just a subset of the variety of different configurations that can be used as and/or in connection with the present invention.

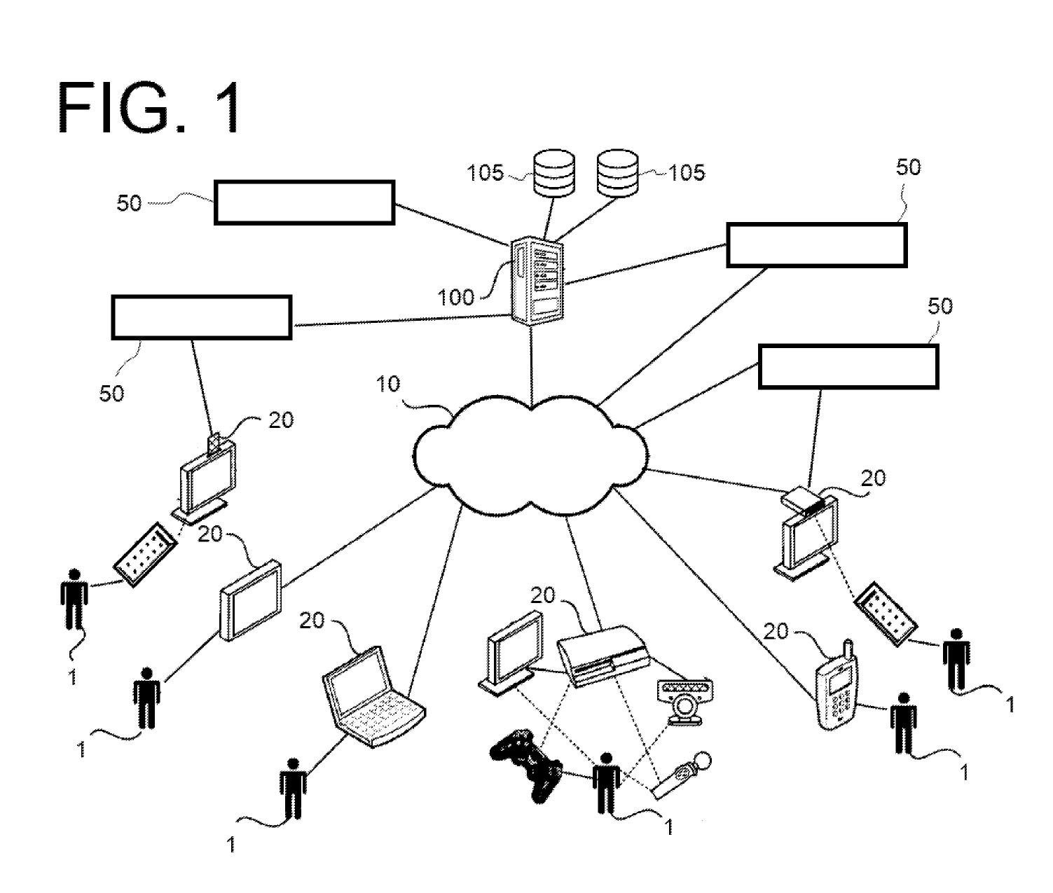

FIG. 1 is an illustration of an example embodiment network useable to deliver user-product interactive advertising content. As shown in FIG. 1, a network 10 provides communicative connection among several different communications devices 20. For example, network 10 could be the Internet or another TCP/IP protocol network such as a WAN or LAN or intranet, or network 10 could be a wireless cell network operating on CDMA, WiFi, Bluetooth, GPS, near field communications, etc. Network 10 may thus be any structure or protocol that allows meaningful communication between devices 20 and/or other information sources.

One or more content providers 50 connect to one or more user devices 20, either directly or via network 10 or another network. Providers 50 can be any content, media, functionality, software, and/or operations providers for communication devices 20. For example, providers 50 may include mobile software developers with server backends and/or access portals for downloading and running software or streaming media on devices 20. Or providers 50 may include a network operator, such as a cellphone and mobile data carrier operating network 10 and controlling access rights of users 20 as well as general operation of network 10. Or providers 50 may be application storefronts providing search, download, operations connectivity, updating, etc. for apps on communication devices 20. Or providers 50 may be a website or ftp server offering downloadable files or other content that may be displayed or otherwise consumed through devices 20. Although providers 50 are mostly shown clustered around network 10 for connectivity to devices 20, it is understood that any direct or indirect connection between any provider 50 and any device 20 is useable in example embodiments.

Example embodiment conversation application host 100 provides verbal interaction, and potentially audible conversation, functionality among devices 20 and ultimately users 1, optionally through providers 50 and/or network 10. For example, host 100 may be connected to several different devices 20 through a network 10. Or conversation application 100 may be connected directly to a content provider 50, to indirectly provide verbal interaction functionality among devices 20. Still further, host 100 may connect directly to a device 20. This flexibility in networking can achieve a variety of different conversation functionalities, content control, and commercial transactions among potentially independent host 100, providers 50, network 10, and/or devices 20.

As shown in FIG. 1, example embodiment conversation application host 100 may be connected to or include computer hardware processors, server functionality, and or one or more databases 105, which may store conversation functionality and/or user or network profile or operational data for successful interaction among various networked components. In this way, host 100 may accept, persist, and analyze data from user communications devices 20, network 10, and/or providers 50.

As used herein, “communication device”—including user communications devices 20—are defined as processor-based electronic devices configured to receive, transmit, and perform conversational content from one or more humans. The conversational content may include audible, spoken communications as well as text-based communications derived from speech. For example, communication devices 20 may include wearable computers and other attendant processing devices, smartphones, media players, GPS units, IPTVs, desktop or notebook computers, personal tracking accessories, media and gaming consoles, etc. that include a processor, persistent storage, communications port or antenna, and audio, audio-to-visual, or visual-to-audio input/output. A “communication device” is further defined to be capable of being programmed or physically configured with hardware to execute example methods described below.

### Example Methods

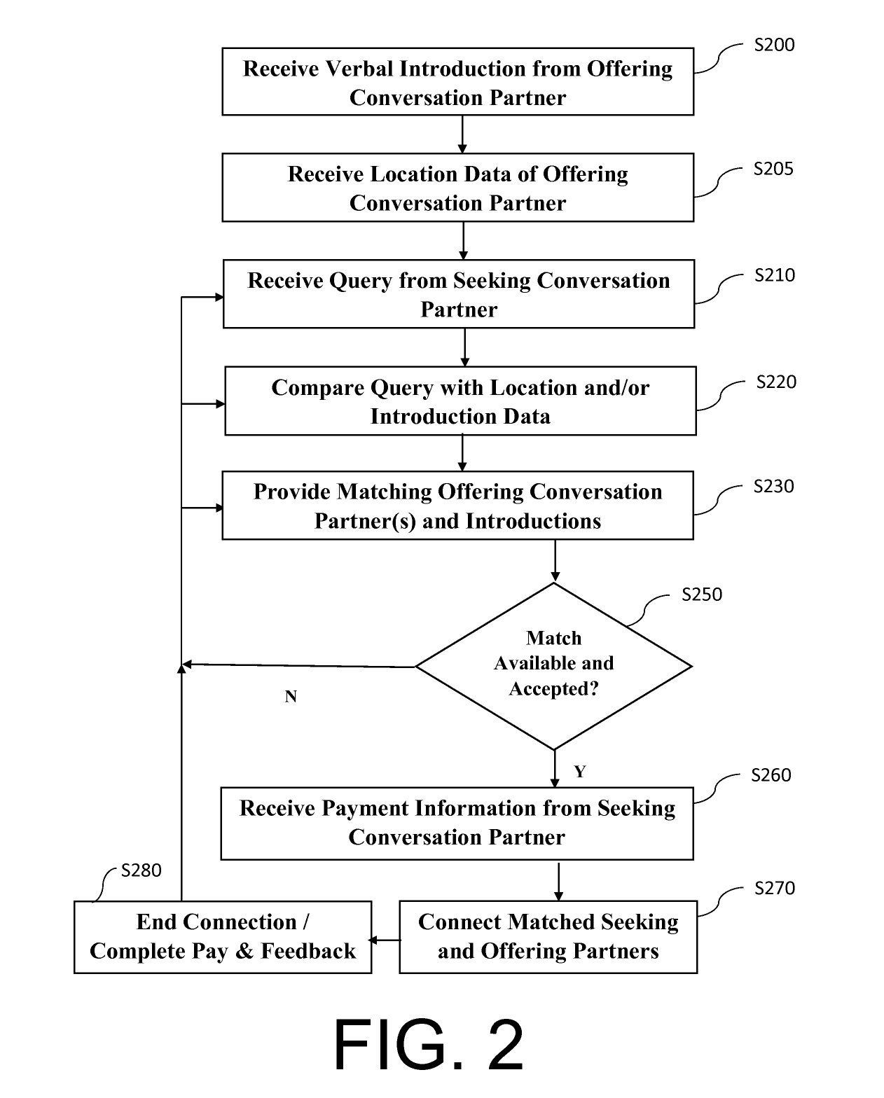

FIG. 2 is an illustration of an example method. As seen in FIG. 2, in S200, a verbal introduction may be performed and is received from an offering conversation partner, a human offering to speak to another, through a communications device. The verbal introduction may generally describe the person, their interests in conversation, or their expertise that can be communicated. In this way, the introduction may function as a “pitch” or description of services offered through speech. The introduction may also give a feel for the offering partner's voice, accent, demeanor, gender, and other vocal qualities. The introduction may be any length; for example, a shorter length, such as 5-30 seconds, may enable faster transmission and consumption of introductions in example methods.

For example, an offering conversation partner may describe their fluency in French and English and offer to converse in both languages to aid a learner's conversation skills; or an offering conversation partner may be at a controlled-access location like inside a bar, game, market floor, courtroom, or concert venue and offer to relay information uniquely available in the venue; or an offering conversation partner may be familiar with a particular area were they reside or work and indicate and describe themselves as an expert in navigating and sightseeing in the area. As seen, the introduction may give any number or different pieces of information about an offering conversation partner and/or potentially valuable conversation content they can offer.

The verbal introduction in S200 may be spoken into an electronic communications device and received at any number of destinations. For example, in the context of FIG. 1, a human user 1 may speak an introduction into a communications device 20. The introduction may be recorded in the local communications device 20, such as through an application running on the local communications device 20 that is configured to execute example methods. The introduction may be transmitted to network 10, application provider 50, example embodiment conversation application host 100, and/or another communications device 20. Such transmission may occur directly or indirectly, potentially with encoding or digitalization, and potentially withy storage at any destination or intermediary.

In an example method using a centralized server model, the verbal introduction generated in S200 may be received and stored in conversation application host 100 that is specifically configured to interact with an application on communications device 20. Host 100 may store the introduction in a dedicated server or permanent database 105 along with user information such as device ID, user profile, user name, account information, date/time of recording, etc. associated with the providing offering conversation partner.

Host 100 and/or communications device 20 may further analyze or otherwise process the introduction received in S200, such as for keywords, removal of background noise, flagging unwanted content, anonymizing the introduction through auditory manipulation, converting a spoken introduction into text, etc. These analyses and modifications may be further transmitted with and/or stored with the introduction in host 100. A user may also provide supplementary information in S200, such as keywords, background or profile information, etc. along with their introduction in S200.

In S205, location information of the offering conversation partner providing the introduction is received. Location may be determined and provided in many ways. In the example of FIG. 1, a communications device 20 may include a GPS antenna and functionality accessible by an application that configured the device 20 to perform example methods. The application may access and retrieve location information from the GPS and transmit the same as location information to be received in S205. Or, for example, a user device 20 may be using a determinable IP address, cellular tower, and/or WiFi network that the application can use to determine location. Or, for example, a user device 20 may interact with an RFID tag or QR code at a unique location that is readable by the application or otherwise location-determinative. Still further, a human user 1 may input his or her location into communications device 20.

Similar to reception of the introduction in S200, location information may be recorded in the local communications device 20, network 10, application provider 50, example embodiment conversation application host 100, and/or another communications device 20, directly or indirectly, potentially with encoding or digitalization, and potentially withy storage at any destination or intermediary. In an example method using a centralized server model, location information generated in S205 may be received and stored in conversation application host 100 from the application on communications device 20. Host 100 may store the location information in a dedicated server or permanent database 105 along with the corresponding verbal introduction and any additional user information of the offering conversation partner for efficient collation and association of all data of an individual offering conversation partner.

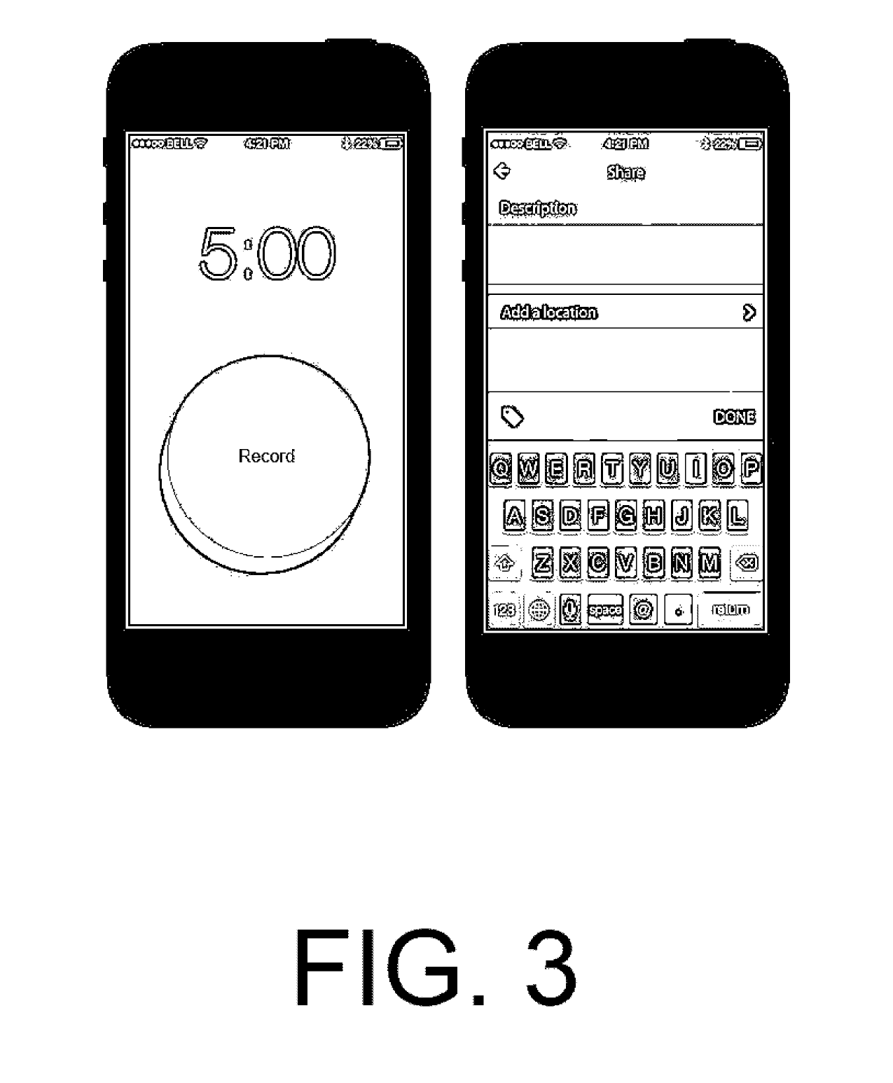

FIG. 3 is an example graphical user interface performable on a communications device of the offering conversation partner to solicit an introduction and/or location for reception in S200 and/or S205. Graphical user interfaces shown as examples herein may be presented by an application installed on the device or through native operating system software or hardware. As shown in FIG. 3, the interface may be relatively simple to facilitate introduction creation, including a record button activatable through a touch screen or cursor to directly enter the introduction. Additionally or alternatively to a simple record option interface, options including keyword selector or entry, user information entry, an active location capture, location entry, privacy options, etc. may be presented in a graphical user interface for entry through a touchscreen or other entry device.

Of course, S200 and S205 may be executed simultaneously or asynchronously. For example, an offering conversation partner may record a single introduction in S200, and the location of the user or device through which the introduction was received may be continuously monitored or periodically updated through automatic or manual location determination thereafter in S205. Similarly, a user may update or change their introduction based on their changing interests and abilities, such that multiple receptions S200 of introductions for the user occur without location reception in S205.

Although only introductions and location information are shown in FIG. 2 as received in S200 and S205, it is understood that other information, previously-mentioned or not, may also be received by a central host 100 controlling example methods, as well as by other devices 20, application providers 50, etc. in example methods. For example, offering conversation partners may additionally provide or have generated user account information, conversation quality ratings and user feedback, address and billing information like bank account or credit card information, chat availability status, biographical information, device power/standby/busy information, privacy preferences, etc. to enable tasks like login, authentication, user verification, identity/age verification, ecommerce transactions, availability determination, information encryption, anonymizing, and/or conditional matching in example methods. In a central control model, all information may be received and stored in ordered format in host 100 for all users. Or in a distributed model, some or all pieces of information may be received by a local communications device 20 from the human operator 1 and appropriately stored, used, and transmitted in example methods.

The receiving introductions and location data in S200 and S205 may be repeated for a large number of distinct offering conversation partners. Each offering conversation partner may have his or her own account, user information, preferences, rating, etc. and provide distinct verbal introductions and location information. As such, information for several different offering partners may be received and potentially stored and analyzed by a controlling, among several different user devices, etc. Similarly, users may provide multiple introductions in S200 that may be saved and toggled between or preserved as user history.

In S210, a seeking conversation partner submits a query for an offering conversation partner. The query may take any form or content. The query may include location and/or desired conversation parameters, such as type or topic. For example, the query in S210 may be a location of the user as determined or entered into their communication device. In the example of FIG. 1, a user device 20 may be using a determinable IP address, cellular tower, and/or WiFi network that an application or operator can use to determine location. Or communications device 20 may include GPS functionality to access and retrieve location information for a query in S210. Or, for example, a human user 1 may input his or her location into communications device 20.

Or the query in S210 may be a plain language search term or keyword entered or spoken into a communications device by a user. For example, a user may enter a search term or keyword like “local events in San Francisco” or “I want to practice my Russian” or “nurse” or “Java” as the query in S210. Such a query entry may permit strict or Boolean logic formatting for more exact parameters. Similarly, the query received in S210 may include both a plain text search term and a keyword and a location.

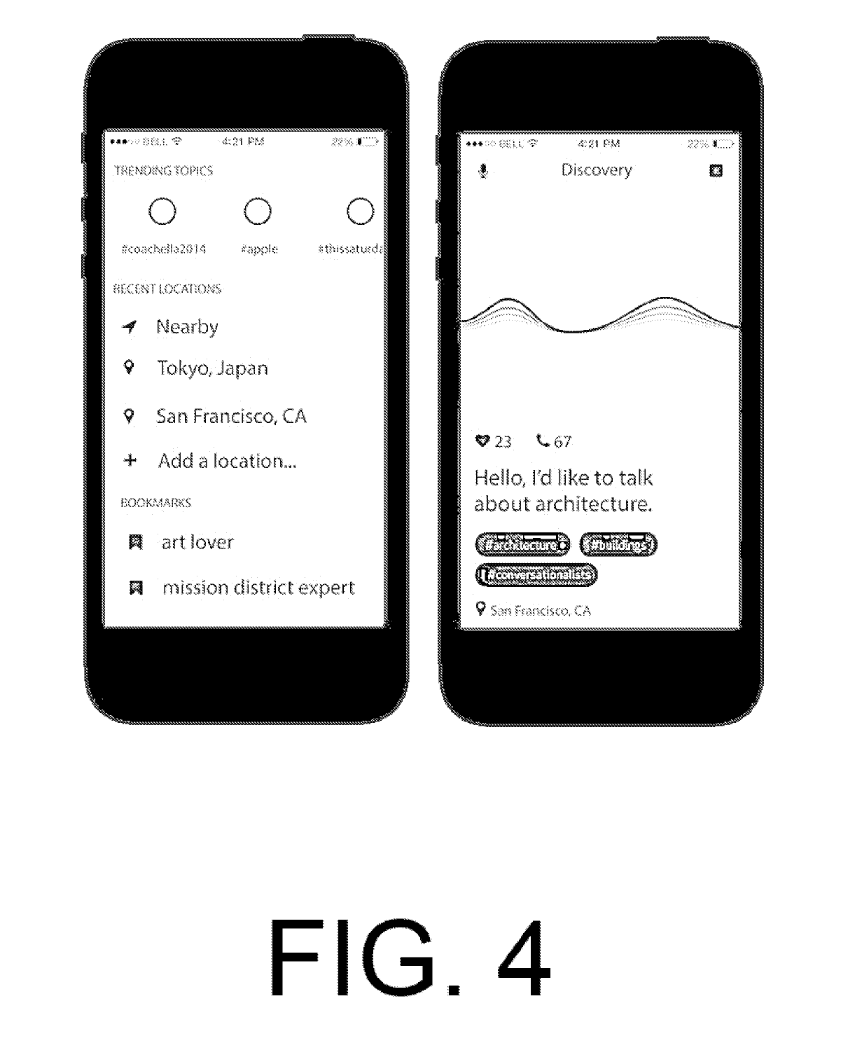

FIG. 4 is an example graphical user interface performable on a communications device of the seeking conversation partner for receiving the query in S210 through an appropriately configured communications device. As shown in FIG. 4, queries in S210 may be received through relatively simple interfaces that include options of selecting keywords, locations, recent entries by the user, trending topics across all users or from other social media, and/or speaking or typing a freeform or logical search string. As such, a user may interact with only a small number of screens with directly-presented options in order to form a query. Of course, additional screens with potentially finer details regarding privacy, screening users or content, exact search formats, and/or expanded suggestions may be presented to users to harvest more detailed queries in S210.

The query in S210, for example made by a user 1 through a communications device 20 as in FIG. 1, may be stored or forwarded to any destination as part of its reception. For example, in a distributed model, a local application running on communication device 20 may intake a query through a microphone and touchscreen and store the same in local storage and/or act on it in accordance with example methods. Or, for example, in a central host model, a local application may forward the query received in S210 to a central host 100 or otherwise acted on in accordance with example methods. In any model, the query may be stored in association with other user details of the seeking conversation partner, including account information, privacy settings, favorites, payment information, usage history, ratings, etc.

Although receipt of information from an offering conversation partner in S200 and S205 are shown in single and directly preceding receipt of a single query from a seeking conversation partner in S210, it is understood that these receipts may occur independent of one another, in any order, and in pluralities from several different offering conversation partners and seeking conversation partners. All subject matter received in S200, S205, and S210 may be persisted over time in central host(s) and/or among several communications devices connected to one another for appropriate usage in example methods regardless of synchrony, numerosity, or order of S200, S205, and S210.

As shown in FIG. 2, in S220, the received query from S210 is compared with the location and/or introduction data from S200/S205. The comparison in S220 determines a match(es), or a fitness of match(es) above a threshold, between the query of a seeking conversation partner and introduction/location of an offering conversation partner(s). For example, matches may be based on location, and only offering conversations partners and seeking conversation partners within a certain mile radius may be considered a match in S220. The mile radius may be set as a portion of the query in S210, as a stored user setting for the offering and/or seeking conversation partner, as a system default, as a variable to be increased to yield a number of results above a threshold, etc. The matches may use cellular data, GPS coordinates, etc. to determine distance between offering and seeking partners. Location-based matches may use a municipal location or geographic or jurisdictional boundary in S220. For example, a query in S210 may include a latitude and longitude within Chicago, Ill., US, and only location data received in S205 from offering conversation partners within the city limits of Chicago, which may be determined through WiFi access point, IP address, GPS, etc. may yield matches in S220.

Or, for example, comparison may be made based on keyword, hashtag, Boolean parameters, verbal string comparison, etc., either in combination with or regardless of location. For example, a provided query including “how to repair a flat tire” may successfully match against a provided introduction having the extracted terms “fix,” “repair,” “automotive,” “car,” “roadside help,” etc. from an introduction. Comparison in S220 may invoke known searching methods to best match seeking and offering conversation partners, including spelling-correction, context-based searching, keyword extraction and ranking, and/or heuristic learning based on query history.

Comparison in S220 may also take into account other user-provided parameters as well as other quality-increasing parameters. For example, comparison in S220 may compare seeking user preferences, such as age range, gender, native language, user feedback rating, entered through an application or otherwise, against account information in offering partner's accounts to screen or rank matches between seeking and offering partners. The reverse comparison of offering against seeking partner information may also be made. Similarly, comparison in S220 may account for offering user unavailability flags, busy statuses (such as being in another conversation), and/or lower connectivity, in order to remove such offering users or reduce their fitness of match determined by comparison S220. Further, for example, comparison in S220 may look at offering user history and feedback—both overall and in connection with query terms—against query parameters. Additionally, adult, illegal, or wasteful subject matter in offering or seeking information may be identified and excluded in comparison S220 and/or all other information containing such subject matter may be equally excluded or decreased in match quality in S220.

As such, it is understood that comparison in S220 may be multi-factored and balance a number of variables, directly entered, derived, or accessed through other information sources, in several ways. An example of a highly-specific algorithm would include summing a query-keyword-and-intro match and overall offering conversation partner rating while subtracting the age of the offering conversation intro and ping time of offering user against central host, all translated to comparable variables based on their normal ranges. This example arithmetic could be performed for all available offering conversation partners within a threshold location or keyword match quality, resulting in a list of offering conversation partners each with a single quality value that evenly reflects how much a seeking partner's query matches an offering conversation partner's interests and skills, how well others have interacted with the offering partner, how close the offering partner is, and how well-connected the offering conversation partner is for purposed of information exchange.

The comparison in S220, which may be a multi-factor comparison using big data across many users as shown above and/or may include heuristic methods involving large volumes of search histories, is carried out by a computer hardware processor having appropriate speed and configuration—through hardware or software—as well as access to necessary data, to compare offering and seeking partner information. For example, in a central processing method, host 100 may include a processing cluster and access to programming and stored data in databases 105. Introduction, location, and query data from S200, S205, and S210 may be received at host 100 from user devices 20, potentially through network 10. The processor in host 100 may compare many queries from many distinct seeking partners against many introductions from many offering partners, potentially in real-time as well as using previously-stored queries/introductions. The comparison may also compare locations associated with the partners as well as other search parameters, discussed above or not, like user preferences, content filters, privacy options, etc. Through this comparison the host 100 may determine matches and potentially fitness/rank of match.

Or, for example, in a distributed method, communications devices 20 and/or providers 50 may receive requisite data in S200, S205, and S210. With appropriate configuration, communications devices 20 and/or providers 50 may perform the comparison in S220. As such, it is understood that a human user 1 may enter a query into their communication device 20, which may also receive numerous instruction and location data in S200 and S205 (at any point in time) and determine matches through comparison in S210. That is, example methods may be executable wholly on programmed communications devices 20 of human users 1, especially if each device 20 handles the queries of only a single user 1 at any given time.

In S230, a match(es) from the comparison in S220, if any, are provided to the seeking conversation partner. For example, all offering partners within a set mile radius to the seeking conversation partner having introductions with keywords matching a query from the seeking partner may be displayed to the seeking partner through user device 20 in S230. Or, for example, offering conversation partners may be presented in a scrollable list ordered by proximity or other goodness of match parameters determined in S220. As such, seeking partners in S230 may be shown a list of offering partners ordered from closest, highest-ranked, most completed conversations on a queried topic, best connection, closest in age/gender/native language/degree/certification, best price, etc. to the opposite at the bottom of the list.

A seeking conversation partner is presented with the introduction provided by each returned match in S230. For example, introductions associated with each returned match in S230 may begin playing to the seeking conversation partner upon a selection by the seeker or automatically. The seeking conversation partner may listen to the introduction in full or select a stop or next option to move to another introduction. Or, for example, as the seeking conversation user scrolls through an ordered list of returned matched in S230, the introduction from a highlighted or top match may be performed. The matches presented in S230 may also be shown with criteria that caused the offering partner to be displayed. For example, a location or distance indicator, or a rating, may be shown with each match in S230. A seeking conversation partner may also access more detailed information about the returned matches, such as through a user profile or account page. Finally, matches shown in S230 may be relatively anonymous, without displaying personally identifying information or exact locations of offering conversation partners returned as matches.

In S250, seeking partners may select a displayed match from S230. If no match is presented or if no match is acceptable to the user, any of querying, comparing, and providing in S210, S220, and 230 may be reiterated. For example, if no match is found in S220 and S230, a user may be prompted to reenter a reformatted or less restrictive query in S250. Or if no match is acceptable to the user, the user may select an option to reenter a new query in S210. Still further, a user may request to be shown additional matches after scrolling to an end of a list of matches, in which case S220 and S230 may be re-executed and return additional and/or lower quality matches. Yet further, a user may input new comparison criteria or re-sort the matches provided in S230 by a specific category—like distance, expertise, rating, etc.—in which case S230, and potentially S220 may be re-executed and a newly-sorted list of matches may be presented to the user.

As shown in FIG. 2, if a presented match for conversation is selected/accepted in S250, the seeking conversation partner may be presented with a payment option in S260. Payment amount may be based on any number of factors, including length of conversation, rating of selected conversation partner, topic of discussion, geography, payment method, user histories, etc. Payment may be metered in any number of ways as well, such as through pre-paid units, through an ongoing meter, in a summary at call end, etc. Metering options may also be based on factors that reflect reliability of payment, including funding source reliability and/or verification. Payment may be achieved through any system, including known ecommerce systems like PayPal, credit cards, EFTs from bank accounts, Square, etc. Payment options and preferences may be selected by the seeking user in S260 and/or may be pre-set or pre-verified through user account settings. In light of all these payment variables, it is understood that different users may be presented with different payment options and charge amounts payable in different manners based on any number of criteria that reflect supply-and-demand, achieve system stability, improve user experience, maximize payment likelihood, etc.

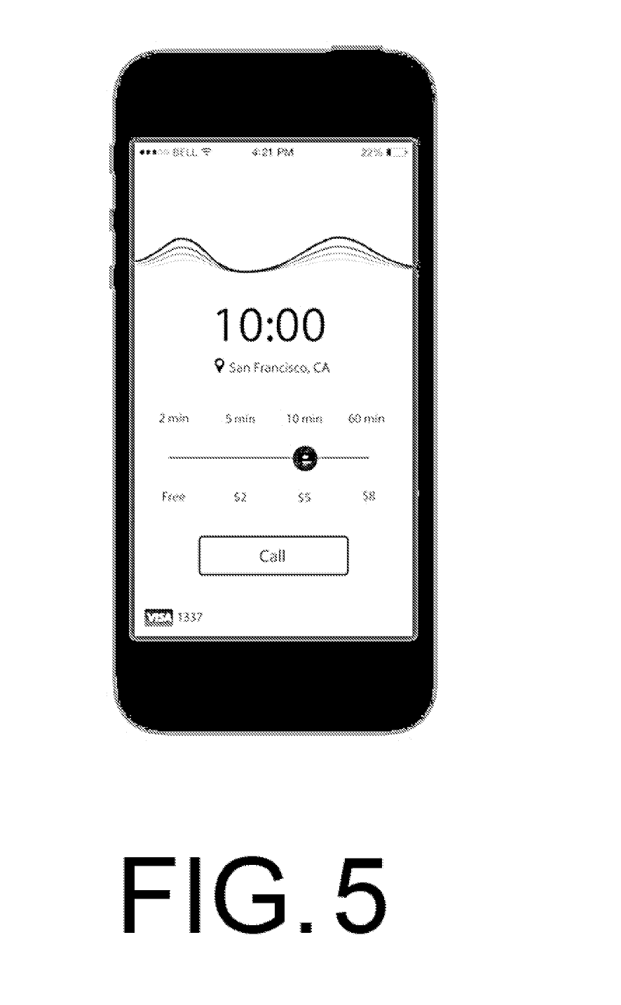

FIG. 5 is an example graphical user interface performable on a communications device of the seeking conversation partner for selecting pre-paid options with a stored credit card. As shown in FIG. 5, the seeking user may be presented with an amount of time versus cost prior to starting the conversation with the selected partner in S260. The user may interact with a touchscreen or cursor to move a slide to a desired amount of pre-paid time and associated cost. Upon touching call, the application may proceed to charge the identified Visa card the amount selected by the slider. Charging may be achieved through known electronic merchant account interfaces through communications device 20, provider 50, host 100, etc. depending on method centralization or distribution. Charges may be credited to the selected offering conversation partner, and application provider, and/or the method operator or host, for example.

As shown in S270 of FIG. 2, following receipt of payment information, the selected offering conversation partner and seeking conversation partner may be connected to converse through their communications devices. For example, applications on communications devices 20 may connect through voice-over-IP protocols, radio frequencies, and/or cellular voice networks so that the matched partners may speak. Each partner may have a known IP address, telephone number, or other network identifier that permits the partners to establish an exclusive audible connection over these and other technologies without necessarily divulging identifying or personal information.

As such, it is possible for connected seeking and offering partners in S270 to be provided with a relatively simple notification of connection and potentially a user name with general information such as city, native language, age, account rating, etc. of the other partner. Similarly, offering partners may be provided a keyword or query string that resulted in the match, in order to better contextualize the conversation. Offering partners may also be provided with a notification, such as a ring or a prompt through their communications device, making them aware of a match, selection, and payment associated with them, in order to promptly respond to the connection in S270. Offering partners may also be able to send an acknowledgement, a decline, a postponement potentially with another time for the connection, and/or immediately begin conversing in response to such a notification. In this way, because offering conversation partners may not be aware of several intervening steps of example methods pursued by seeking conversation partners, the offering conversation partner may have some time and information to properly accommodate the call,

When connected in S270, partners may speak about any topic desired, although it is expected that the conversation will be limited to the context of the query, such as conversation about a searched issue, help topic, or keyword. The parties may be provided with a running meter of call time, time remaining in the case of a pre-paid option, ongoing charges, etc. during the connection in S270. The parties may also be provided with an option to end the conversation. The seeking conversation partner may also be provided with an option to drop the current connection in S270 and to connect to another—potentially next-best—matched conversation partner from S230, under the same or different billing option, essentially looping and condensing S230, S250, S260, and S270 into a single “next” option for the seeking conversation partner.

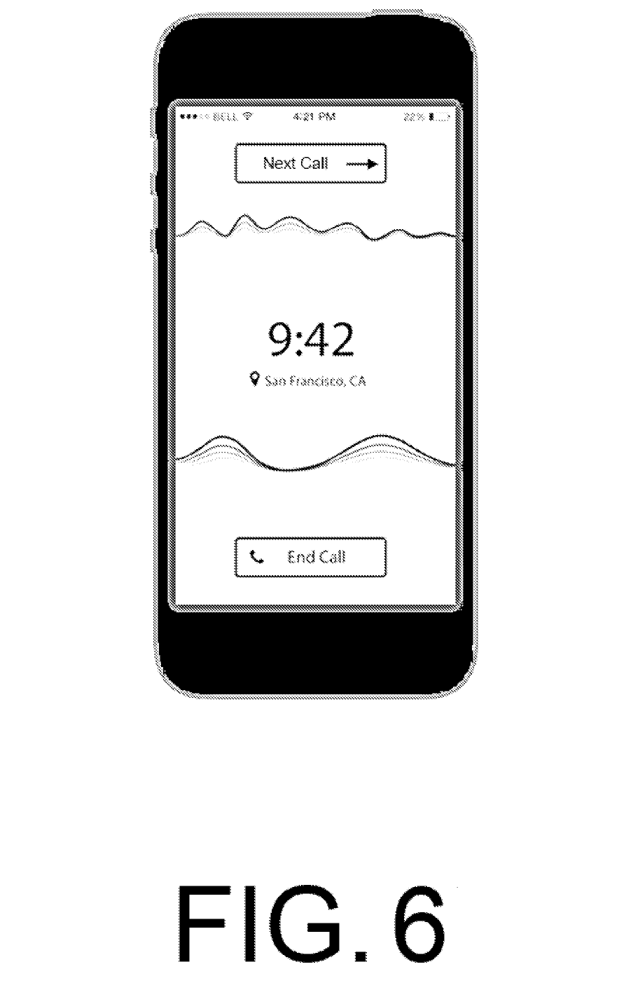

FIG. 6 is an example graphical user interface performable on a communications device of the seeking conversation partner. As seen in FIG. 6, a meter reflecting current length of an ongoing connection may be displayed to the user. Some contextual information, such as city and state, of the connected offering conversation partner may also be displayed. Further, options to end the call and/or continue the call with the next match may be provided for selection through the graphical user interface.

In S280, payment may be completed and/or feedback may be left between partners of a completed connection from S270. For example, in a non-pre-paid mode, a final length and associated cost of the connection from S270 may be finalized and billed to the selected payment method from S260. Confirmation and/or payment shares to an offering conversation partner may be provided in S280. A seeking conversation partner, and potentially an offering conversation partner, may be prompted to provide feedback or ratings of the conversation from S270 in S280. For example, a seeking partner may rate how well the matched conversation partner satisfied the conversational needs of the seeking partner on a provided scale and/or provide detailed feedback about the conversation, including connection problems, conversational shortcomings, and/or where expectations were exceeded. Feedback information, as well as general connection statistics, may be saved for each partner, potentially in association with a user account, to generate an overall feedback profile or rating that may in turn be used in comparing and matching in S220 and S230. Following connection termination in S280, a seeking conversation partner may be returned to matching information in S230 and/or prompted to enter a new query in S210, for example.

Any of the actions in S200-S280 may utilize a single or multiple interfaces, actors, and resources to achieve conversation partner connections, potentially through multiple-party control. Example methods may work through programming provided to communications devices and networks by way of a modular software development kit. For example, a gaming application or operating system universal help interface may call functionality to locate a conversation partner on a user device using example methods. Such functionality may be provided through an interface with a host controlling the method in a centralized manner, or may be integrated with the calling application or operating system.

As discussed at several points above, a single or multiple parties may control any action of example methods in a centralized or distributed operation format. For example, a properly programmed or hardware-configured first communications device 20 can execute the receiving S200 and S205 from an offering conversation partner who is a human user 1 of the device. A properly programmed or hardware-configures second communications device 20 may execute the remainder of actions S210-S280 upon receipt of data from potentially several first communications device(s) 20 on which to act. First communications device 20 may again participate in the connection of S270. Such proper configuration may be installed on devices 20 through an application download and installation and/or provided natively in the device or operating system.

Or, for example, an application provider and/or host may execute actions in example methods. For example, a centralized host 100 may receive information in S200-S210 from at least two different users 1. The centralized host may proceed with the analysis and providing results in S220 and S230, receive a selection indication in S250 and payment information in S260, and facilitate the connection in S270, potentially through a VoIP server in host 100. Still further, different actions of example methods may be performed by different providers, potentially among several different servers and user devices controlled and operated by mutually exclusive or overlapping parties.

Although various actions within the method of FIG. 2 are described using examples of audio or voice introduction/conversation, it is understood that text-based communications may also be used. For example, a partner's spoken conversation or other information may be converted to text, such as for hearing-impaired users. Similarly, text-based communications and other information may be converted to spoken, audible output for users unable to safely input text. Such conversation may be achieved through appropriate programming of a communications device or a native speech-text conversion functionality thereon, or through another actor in an example network.

Actions in example methods may include user authentication, data verification, and privacy controls. For example, throughout example methods, conversation partners may never be provided with identifying information of the other beyond general location and user conversation parameters. A connection in S270 may further be analyzed in real-time or later through recordation for personally identifying information or contact information, to ensure that exchange of such information is monitored and potentially prevented and/or punished. Moreover, the connection in S270 may use anonymizing methods such as converting all speech to text and/or altering audible characteristics to keep partner identity private. Similar methods may be used to identify, screen, and potentially punish or prevent entry or sharing of adult, illegal, or wasteful content through example methods.

As to verification, example methods may take advantage of a user login model requiring user authentication with a password over a secured connection and/or using operating-system-native security control and verification on user's communications devices, to ensure only verified, permitted human users access example methods and potentially user accounts. Example methods may also require payment verification, such as credit card or bank account authentication, in order to verify identity before allowing users to participate in matching partners in example methods. Example methods may further use location and input verification available through operating system controls or other network functionalities, potentially in combination with user feedback, to prevent or punish location spoofing, user account compromising, bot access, and/or harassment or waste in example methods.

Some example methods being described here, it is understood that one or more example methods may be used in combination and/or repetitively to produce multiple options and functionalities for users of communications devices. Example methods may be performed through proper computer programming or hardware configuring of networks and communications devices to receive introductions, locations, and queries and act in accordance with example methods. Similarly, example methods may be embodied on non-transitory computer-readable media that directly instruct computer processors to execute example methods and/or, through installation in memory operable in conjunction with a processor and user interface, configure general-purpose computers having the same into specific communications machines that execute example methods.

Example methods and embodiments thus being described, it will be appreciated by one skilled in the art that example embodiments may be varied through routine experimentation and without further inventive activity. For example, although a direct comparison between offering and seeking partner input may be used to generate a match, it is understood that vastly more complex analysis and input may be used to determine and rank matches. Variations are not to be regarded as departure from the spirit and scope of the exemplary embodiments, and all such modifications as would be obvious to one skilled in the art are intended to be included within the scope of the following claims.

What is claimed is:

1. A method of matching conversation partners through communication devices, the method comprising:
receiving a query from a first user through a communication device;
comparing, with a computer hardware processor, the query against at least one of location and introduction information from a second user;
providing results from the comparison to the first user, wherein the results include the second user and the introduction information from the second user;
receiving, from the first user, a selection corresponding to the second user from the results; and
connecting the first user and the second user to converse.

2. The method of claim 1, further comprising:
receiving payment information from the first user, wherein the connecting is performed after the receiving the query, the comparing, the providing, the receiving the selection, and the receiving payment; and
obtaining payment from the payment information based on the connecting.

3. The method of claim 1, wherein the providing results is executed on the communication device by visually displaying the results to the first user, wherein the receiving the selection is executed through the communication device, and wherein the connecting is executed through the user device.

4. The method of claim 1, further comprising:
receiving, through a second communication device, the introduction and the location information from the second user.

5. The method of claim 4, further comprising:
receiving additional introduction and location information, each from a plurality of additional users, wherein the comparing compares the query against all received introduction and location information, wherein all of the first, the second, and the additional users are human.

6. The method of claim 4, wherein the connecting is executed through the user device and the second user device.

7. The method of claim 1, wherein the query includes a location of the first user, wherein the location data includes a location of the second user, and wherein the comparing determines a distance between the first user and the second user.

8. The method of claim 7, wherein the results include the distance, and wherein the distance is within a threshold distance for providing the second user in the results.

9. The method of claim 1, wherein the connecting is executed using voice-over-IP between two communications devices.

10. The method of claim 1, wherein the comparing further includes determining an availability status of the second user and analyzing a feedback rating of the second user, and wherein the providing results includes ranking the second user among several users based on the comparing.

11. The method of claim 1, further comprising:
receiving, from the first user, feedback of conversation quality with the second user following the connecting.

12. The method of claim 1, further comprising:
receiving, from a plurality of the second users through a plurality of second communication devices, introduction and the location information for each of the second users, wherein,
all first and second users are human,
the query includes a location of the first user and a conversation topic,
the location data includes locations for each of the second users,
the comparing determines distances between the first user and each of the second users based on the locations and compares the conversation topic against the introduction information for each of the second users, and
the results include at least a subset of the plurality of the second users ordered based on the comparing and introduction information from each of the subset,
the results are provided on the first communication device; and
receiving payment information from the first user, wherein the connecting is performed after the receiving the query, the comparing, the providing, the receiving the selection, and the receiving payment;
obtaining payment from the payment information based on the connecting, wherein a portion of the payment is given to the selected second user; and
receiving, from the first user through the communication device, feedback of conversation quality with the second user following the connecting.

13. A method of filtering conversation partners using networked communications devices, the method comprising:
comparing, with a computer hardware processor, a plurality of queries against a plurality of introductions, wherein each query of the plurality of queries from a seeking conversation partner, and wherein each introduction of the plurality of introductions is from an offering conversation partner;
ranking the offering conversation partners for each query based on similarity between the introduction from the offering conversation partner and the query;
providing the ranking to each seeking conversation partner through a communications device associated with the seeking conversation partner, wherein the ranking includes representations of the offering conversation partners as ordered by the ranking for the query from the seeking conversation partner, wherein the results include the introductions each associated with one of the representations that corresponds to the offering partner who provided the introduction;
receiving, from each seeking conversation partner, a selection of one of the representations from the results; and
connecting each seeking conversation partner with the offering conversation partner associated with the selected representation through communications devices associated with the seeking conversation partner and the selected offering conversation partner, wherein the connecting establishes a verbal connection over which a conversation may be had.

14. The method of claim 13, further comprising:
receiving payment information from each seeking conversation partner, wherein the connecting is performed after the receiving the query, the comparing, the providing, the receiving the selection, and the receiving payment; and
obtaining payment from the payment information based on the connecting.

15. The method of claim 13, wherein the connecting is executed using voice-over-IP between two communications devices.

16. The method of claim 13, wherein each query includes a location of the seeking conversation partner associated with the query, wherein each introduction includes a location of the offering conversation partner associated with the introduction, and wherein the comparing determines a distance between each conversation seeking and offering partner, and wherein the ranking is by the determined distance.

17. The method of claim 13, further comprising:
receiving, from each seeking conversation partner, feedback of conversation quality with the offering conversation partner from the connecting.

18. A non-transitory computer readable medium storing data structures that instruct a computer processor in a communication device to,
receive a query from a first user of the communication device;
provide results of a comparison of the query against at least one of location and introduction information from a second user, wherein the results include the introduction information from the second user;
receive a selection of the first user from the results; and
connect to a communication device of the second user for conversation.

19. The computer readable medium of claim 18, wherein the data structures further instruct the processor to,
receive payment information from the first user prior to the connecting.

20. The computer readable medium of claim 19, wherein the query includes conversation subject matter entered into the communication device by the first user and location information determined by the communication device.
